(19) United States
(12) Patent Application Publication
(10) Pub. No.: US 2024/0127700 A1
(43) Pub. Date: Apr. 18, 2024

(54) METHOD FOR MANAGING FLIGHT PARAMETERS OF AIRCRAFT

(71) Applicants: Airbus SAS, BLAGNAC (FR); Airbus Operations SAS, TOULOUSE (FR)

(72) Inventors: Patrice ROUQUETTE, TOULOUSE (FR); Thierry PAYA-ARNAUD, BLAGNAC (FR); Brice BERGANTZ, TOULOUSE (FR); Bertrand MASSON, BLAGNAC (FR); Julien DELBOVE, BLAGNAC (FR)

(21) Appl. No.: 18/480,092

(22) Filed: Oct. 3, 2023

(30) Foreign Application Priority Data
Oct. 5, 2022 (FR) 2210197

(51) Int. Cl. G08G 5/00

(52) U.S. Cl. CPC G08G 5/0039; G08G 5/0034

(57) ABSTRACT

A system for managing flight parameters of aircraft is parametrized with overarching flight cost objectives. For a first flight, parameters of a cost function for the first flight are determined relative, respectively, to different cost factors. Flight parameters are optimized so as to minimize the cost function. Avionics of an aircraft carrying out the first flight are programmed with the flight parameters. On detecting an event in flight requiring the flight parameters to be revised, the parameters of the cost function are recalculated, as well as the flight parameters, and the avionics are reprogrammed accordingly. The method is repeated for at least a second flight, taking into account the effective contribution of the first flight to the overarching objectives, and so on. Thus, an airline can carry out overarching multi-objective optimization on its flights.

### CROSS-REFERENCES TO RELATED APPLICATIONS

This application claims the benefit of the French patent application No. 2210197 filed on Oct. 5, 2022, the entire disclosures of which are incorporated herein by way of reference.

### FIELD OF THE INVENTION

The present invention relates to the field of managing flight parameters of aircraft.

### BACKGROUND OF THE INVENTION

Each airline seeks to minimize the cost of operating its air routes and its fleet of aircraft. It has to be understood that a fleet of aircraft comprises several aircraft and typically numerous aircraft.

The cost of operating an aircraft flight is currently controlled by virtue of a cost index.

The cost index makes it possible to adjust and to optimize the costs of operating an aircraft flight by taking into account the flight time, to which salary and maintenance expenses are proportional, as well as the fuel consumed, which is proportional to the thrust and to the flight speed.

The cost index is a parametrizable datum used in flight management systems (FMSs) on board aircraft. The closer the cost index tends to zero, the more flight management systems (FMSs) generate flight profiles which minimize fuel consumption; and the further the cost index moves away from zero, the more flight management systems (FMSs) generate flight profiles which minimize flight time.

Although the cost index makes it possible for airlines to define an optimization objective on the basis of the cost of fuel consumed and of the cost of flight time, the cost index does not reflect the reality of the modern objectives of airlines, which are to minimize costs of many other kinds (for example, environmental impact, noise etc.). The cost index is, for example, not adapted to incorporate costs of delays, meteorological uncertainties or environmental footprint.

In addition, the cost index is at present used only on the scale of each mission (the journey of the aircraft from a departure airport to a destination airport) and does not make it possible to carry out overarching optimization at network level (the set of airports at which the aircraft of an airline operate), at the level of planning (the flight timetables), or at the level of allocating the fleet (choosing the aircraft to be assigned to such or such an air route), for an airline.

It is then desirable to mitigate these drawbacks of the prior art. It is notably desirable to provide a solution which makes more overarching multi-objective optimization possible for airlines.

### SUMMARY OF THE INVENTION

To this end, a method implemented by electronic circuitry of a system for managing flight parameters of aircraft is proposed, the system for managing flight parameters of aircraft being parametrized with overarching flight cost objectives, the method comprising the following steps:
defining, depending on the overarching flight cost objectives, for a first flight, the parameters of a cost function F for the first flight relative to N different cost factors Fi;
optimizing flight parameters so as to minimize the cost function F;
programming avionics of an aircraft carrying out the first flight with the flight parameters;
on detecting an event in flight requiring the flight parameters to be revised, recalculating the parameters of the cost function F for the flight relative to the N different cost factors Fi, recalculating the flight parameters, and reprogramming the avionics accordingly;
determining an effective contribution of the first flight to the overarching objectives; and
repeating the method for at least a second flight, taking into account the determined effective contribution.

Thus, an airline can carry out overarching multi-objective optimization on its flights.

In one particular embodiment, the parameters of the cost function F are coefficients Ci, with i=1, . . . , N, associated, respectively, with the different cost factors Fi according to the formula:

$$F = {\sum }_{i = 1}^{N} ( {C}_{i} * {F}_{i} )$$

In one particular embodiment, the method further comprises the following step, for determining the effective contribution of the first flight to the overarching objectives: retrieving the flight parameters which were actually applied by the avionics during the first flight.

In one particular embodiment, the cost factors Fi include at least: financial costs, environmental costs, costs of meteorological uncertainties, and costs of the risk of flight planning delays.

In one particular embodiment, the flight parameters include at least: vertical trajectory, lateral trajectory, speed, and thrust.

In one particular embodiment, the system for managing flight parameters of aircraft is implemented exclusively in a computer platform of a control center of an airline.

In one particular embodiment, the system for managing flight parameters of aircraft is implemented jointly by a computer platform of a control center of an airline and the avionics of the aircraft.

In one particular embodiment, electronic flight bags serve as intermediaries between the computer platform of the control center of the airline and the avionics of the aircraft, possibly in addition to wireless communications.

In one particular embodiment, as each flight is composed of a series of flight segments, different flight parameters are applied to each flight segment automatically by the avionics, or by being configured by a pilot.

A computer program product is also proposed, which can be stored on a medium and/or downloaded from a communication network in order to be read by a processor. This computer program comprises instructions for implementing the above-mentioned method when the program is executed by the processor. A non-transitory information storage medium is also proposed, on which such a computer program is stored.

A system for managing flight parameters of aircraft is also proposed, the system for managing flight parameters of aircraft being parametrized with overarching flight cost objectives and comprising electronic circuitry configured to implement the following steps:
defining, depending on the overarching flight cost objectives, for a first flight, parameters of a cost function F for the first flight relative to N different cost factors Fi;
optimizing flight parameters so as to minimize the cost function F;
programming avionics of an aircraft carrying out the first flight with the flight parameters;
on detecting an event in flight requiring the flight parameters to be revised, recalculating the parameters of the cost function F for the flight relative to the N different cost factors Fi, recalculating the flight parameters, and reprogramming the avionics accordingly;
determining an effective contribution of the first flight to the overarching objectives; and
repeating the method for at least a second flight, taking into account the determined effective contribution.

### BRIEF DESCRIPTION OF THE DRAWINGS

The above-mentioned features of the invention, as well as others, will become more clearly apparent from reading the following description of at least one example of an embodiment, the description being given in relation to the appended drawings, in which:

FIG. 1 schematically illustrates a flowchart of a method for managing flight parameters of aircraft;

FIG. 2A illustrates a first exchange scheme;

FIG. 2B illustrates a second exchange scheme;

FIG. 3 schematically illustrates an example of a hardware platform making it possible to implement the method for managing flight parameters of aircraft; and

FIG. 4 schematically illustrates a series of flight segments during which different flight parameters are applied.

### DETAILED DESCRIPTION OF THE PREFERRED EMBODIMENTS

So as not to confuse the innovative cost index proposed here with the cost index used until now in aeronautics, the innovative cost index proposed here is called the “smart index”.

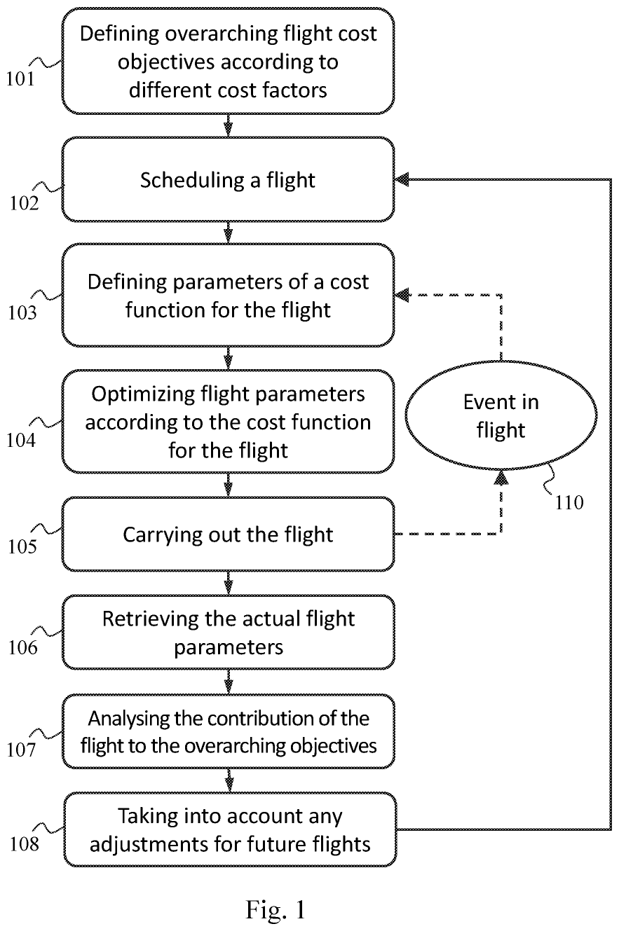

FIG. 1 thus schematically illustrates a flowchart of a method for managing flight parameters of aircraft.

As detailed below, the method for managing flight parameters of aircraft is based on defining parameters of a cost function which takes into account different cost factors linked to operating aircraft. In one particular embodiment, these parameters of the cost function are weighting coefficients of the different cost factors linked to operating aircraft.

In a step 101, the airline defines overarching flight cost objectives according to different cost factors linked to operating aircraft. These cost factors are, for example, representative of financial costs (commercial costs, taxes, maintenance expenses), environmental costs (CO2 emissions, other sources of radiative forcing, noise, air quality, amount of unburned fuel, number of particles emitted), costs of meteorological uncertainties, costs of the risk of flight planning delays, etc. A system for managing flight parameters of aircraft is then parametrized with these overarching flight cost objectives. More specifically, a computer platform of a control center of the airline is parametrized with these overarching flight cost objectives.

In a step 102, the system for managing flight parameters of aircraft obtains a schedule of an aircraft flight from a departure airport to a destination airport, with an expected departure timetable and an expected arrival timetable.

In a step 103, the system for managing flight parameters of aircraft defines parameters of the cost function F for the flight relative, respectively, to the N different cost factors Fi. For example, the cost function F is a combination of the N cost factors, which is variable depending on the parameters of the cost function F. The cost function F can be a linear or non-linear function, or even an algorithm manipulating cost factors according to the defined parameters of the cost function F.

The set of these parameters of the cost function F for the flight, or a value which is derived therefrom, forms the smart index.

The system for managing flight parameters of aircraft thus defines parameters of the cost function F depending on the overarching flight cost objectives. The system for managing flight parameters of aircraft can take into account a state of the aircraft under consideration for the flight and/or expected performance of the aircraft under consideration for the flight (age of the aircraft, time elapsed since last maintenance, etc.) when defining these parameters of the cost function F.

In one particular embodiment, the system for managing flight parameters of aircraft defines coefficients Ci (i=1, . . . , N) of the cost function F for the flight (which are therefore the parameters of the cost function F) relative, respectively, to the N different cost factors Fᵢ according to the formula:

$$F = {\sum }_{i = 1}^{N} ( {C}_{i} * {F}_{i} )$$

In this case, the set of these coefficients Cᵢ(i=1, . . . , N), or a value which is derived therefrom, forms the smart index.

In addition, in this case, the system for managing flight parameters of aircraft thus defines coefficients Ci depending on the overarching flight cost objectives. Also, the system for managing flight parameters of aircraft can take into account a state of the aircraft under consideration for the flight and/or expected performance of the aircraft under consideration for the flight (age of the aircraft, time elapsed since last maintenance, etc.) when defining the coefficients Ci.

In a step 104, the system for managing flight parameters of aircraft optimizes flight parameters so as to minimize the fixed cost function F by virtue of the parameters of the cost function F for the flight which are defined in the step 103 (or by virtue of the coefficients Ci (i=1, . . . , N) in the aforementioned particular embodiment).

The different flight parameters are:
Vertical trajectory
Lateral trajectory
Speed
Thrust
etc.

Constraints can be applied to the flight parameters so as to keep the system for managing flight parameters of aircraft within acceptable limits for the aircraft under consideration (inclination, load factor, etc.) and/or within acceptable regulatory limits (noise level depending on altitude and geographical position, etc.).

In order to determine the flight parameters, the system for managing flight parameters of aircraft can use pre-established digital models depending on the aircraft under consideration, the departure airport and the arrival airport, the journey timetable (day, night, etc.) and potentially other data relating to the flight to be carried out.

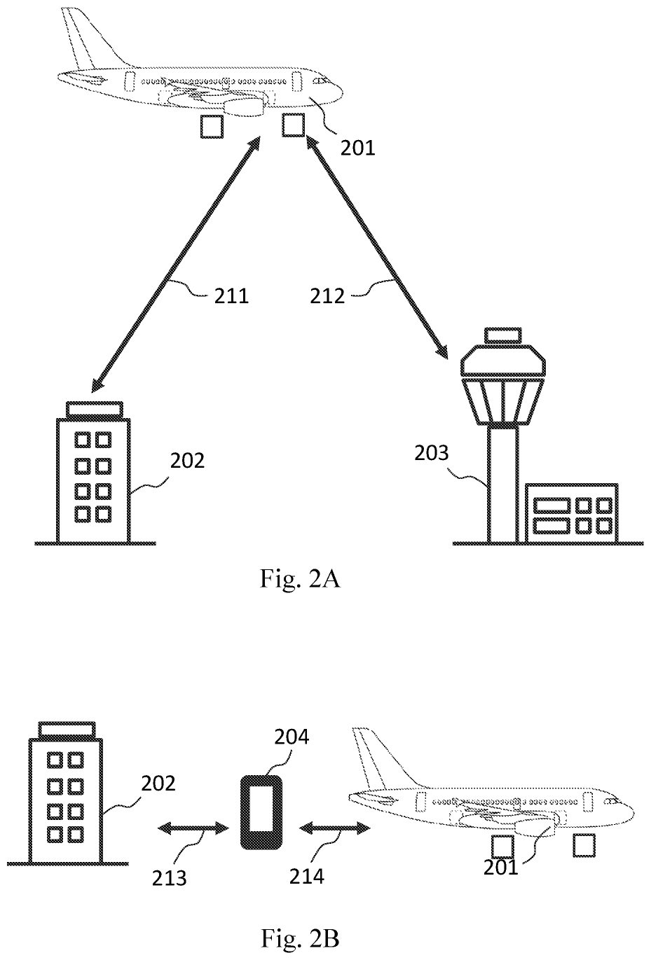

In a step 105, the flight is carried out. The avionics of the aircraft carrying out the flight are programmed with the flight parameters determined in step 104. As detailed below in relation to FIGS. 2A and 2B, the avionics can be programmed with the applicable flight parameters in different ways, notably by wireless communications between the computer platform of the control center of the airline and the avionics, or through a portable electronic device at the disposal of the pilot, referred to as an electronic flight bag (EFB). These electronic flight bags (EFBs) typically take the form of touchscreen tablet computers and typically contain flight mission data, as well as the applications to operate them, or update them, during the flight.

Given that flight conditions can change from what was initially foreseen, flight parameters can undergo modifications during the flight (for example, following an unforeseen meteorological event). Thus, on detecting an event in flight requiring the flight parameters (vertical trajectory, lateral trajectory, speed etc.) to be revised in a step 110, the parameters of the cost function F for the flight (that is to say, the coefficients Ci (i=1, . . . , N) of the cost function F for the flight relative to the N different cost factors Fi, in the particular embodiment already mentioned) are recalculated, and new flight parameters are calculated so as to minimize the cost function F thus redefined, taking into account new constraints potentially brought about by the event in question. Also, the avionics of the aircraft carrying out the flight are reprogrammed accordingly.

In a step 106, the system for managing flight parameters of aircraft preferably retrieves the flight parameters which were actually applied by the avionics during the flight. As detailed below in relation to FIGS. 2A and 2B, the actual flight parameters can be retrieved in different ways, notably by wireless communications between the avionics of the aircraft in question and the computer platform of the control center of the airline, or through the electronic flight bag (EFB) at the disposal of the pilot.

In a step 107, the system for managing flight parameters of aircraft determines an effective contribution of the flight to the overarching objectives, in light of the applied flight parameters, and analyses the effective contribution of the flight to the overarching objectives. Also, in a step 108, the system for managing flight parameters of aircraft accordingly takes into account any adjustments for future flights relative to the overarching objectives. In particular, unforeseen events which occurred in flight could have diverted the aircraft from its initially foreseen trajectory and thus modified the expected impact of the flight on the overarching objectives (CO2 emissions, noise, fuel consumption, etc.).

Then, the step 102 is repeated for a new flight, with the same aircraft or another aircraft. Thus, by virtue of the smart index, the airline can manage its fleet of aircraft, its flight planning, and in general its operations for operating air routes, taking into account its overarching objectives.

FIG. 2A illustrates a first scheme of exchanges between different actors in which the smart index is involved.

On the left, FIG. 2A shows the control center 202 of the airline. On the right, FIG. 2A shows the air traffic control center 203.

Wireless communications 212 (ground-air communications) are established between the aircraft 201, notably in flight, and a computer platform of the air traffic control center 203.

Wireless communications 211 (ground-air communications) are preferably also established between the aircraft 201, notably in flight, and the computer platform of the control center 202 of the airline.

Thus, by virtue of the wireless communications 211, it is possible for the computer platform of the control center 202 of the airline to transmit, to the avionics of the aircraft 201, the smart index or mission parameters (flight plan, flight levels, single or multiple cost index depending on the flight phase, ascent Mach or speed etc.), in order to make it possible for the flight management system (FMS) to take into account the smart index or these mission parameters when calculating a lateral and vertical trajectory with associated time and fuel consumption predictions. It is possible, by virtue of the wireless communications 211, for the avionics of the aircraft 201 to transmit, to the computer platform of the control center 202 of the airline, the flight parameters actually applied during the flight. In a variant embodiment, the flight parameters are calculated by the computer platform of the control center 202 of the airline and transmitted to the avionics of the aircraft 201. These flight parameters can then be modified in flight in order to take into account unforeseen events.

In one particular embodiment, the flight management system (FMS) is able to process only the cost index and not the smart index. In this case, the computer platform of the control center 202 of the airline converts the smart index into an equivalent cost index value or into any other parameter which can be interpreted by the avionics of the aircraft 201, of speed or altitude or position constraint type, and transmits this equivalent cost index value or the parameter to the avionics of the aircraft 201, so that the flight management system (FMS) calculates flight parameters (trajectory, speed, thrust, etc.) adapted to the smart index.

In addition, by virtue of the wireless communications 212, it is possible for the computer platform of the air traffic control center 203 to transmit flight information and instructions to the avionics of the aircraft 201, and to manage events in flight requiring the flight parameters to be revised.

FIG. 2B illustrates a second scheme of exchanges between different actors in which the smart index is involved.

In FIG. 2B, the electronic flight bag (EFB) at the disposal of the pilot serves as an intermediary between the computer platform of the control center 202 of the airline and the avionics of the aircraft 201.

Thus, by virtue of wired (for example, USB (Universal Serial Bus)) or wireless (for example, Bluetooth, Wi-Fi, 4G or 5G) communications 213, it is possible for the computer platform of the control center 202 of the airline to transmit, to the electronic flight bag (EFB), the smart index or the mission parameters. As a variant, the electronic flight bag (EFB) can incorporate a calculation module for calculating the smart index directly. Then, by virtue of wired (for example, USB) or wireless (for example, Bluetooth or Wi-Fi) communications 214, it is possible for the electronic flight bag (EFB) to transmit, to the avionics of the aircraft 201, the smart index or the mission parameters, in order to make it possible for the flight management system (FMS) to take into account the smart index or these mission parameters when calculating a lateral and vertical trajectory with associated time and fuel consumption predictions. In a variant embodiment, the flight parameters are calculated by the computer platform of the control center 202 of the airline and transmitted to the avionics of the aircraft 201 via the electronic flight bag (EFB). These flight parameters can then be modified in flight in order to take into account unforeseen events.

In the particular embodiment where the flight management system (FMS) is able to process only the cost index and not the smart index, the electronic flight bag (EFB) at the disposal of the pilot serves as an intermediary between the control center 202 of the airline and the avionics of the aircraft 201 for transmitting the equivalent cost index value or the parameter which can be interpreted by the avionics of the aircraft 201.

The arrangements schematically illustrated in FIGS. 2A and 2B can be combined in order to exchange, between the control center 202 of the airline and the avionics of the aircraft 201, some of the information via the electronic flight bag (EFB) at the disposal of the pilot and the rest of the information through the wireless communications 211.

Thus, in light of the above, the system for managing flight parameters of aircraft can be implemented exclusively in the computer platform of the control center 202 of the airline, or implemented jointly by the computer platform of the control center 202 of the airline and the avionics of the aircraft 201.

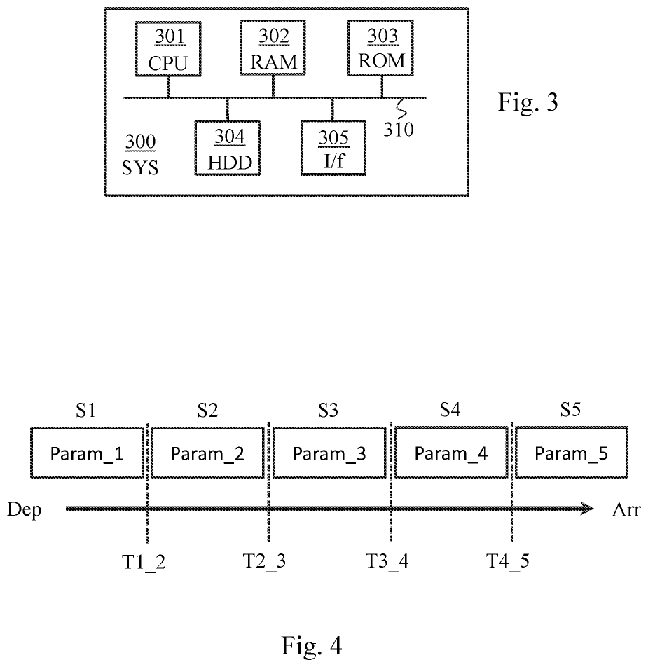

FIG. 3 schematically illustrates an example of a processing system hardware platform 300, in the form of electronic circuitry, which is adapted and configured to implement the functionalities of the system for managing flight parameters of aircraft. The hardware platform 300 is adapted to provide an internal data processing structure to the computer platform of the control center 202 of the airline. The hardware platform 300 is adapted to provide an internal data processing structure to the electronic flight bag (EFB). The hardware platform 300 is adapted to provide an internal data processing structure to the avionics of the aircraft 201.

The hardware platform then comprises the following, connected by a communication bus 310: a processor or CPU (central processing unit) 301; a random-access memory (RAM) 302; a read-only memory 303, for example a ROM (read-only memory) or EEPROM (electrically erasable programmable ROM); a storage unit 304, such as a hard disk drive (HDD) or a storage medium reader, such as an SD (Secure Digital) card reader; and an interface manager (I/f) 305.

The interface manager (I/f) 305 makes it possible to interact with one or more peripheral devices in order to interact with a human operator and/or in order to communicate with a communication system (for example, in order to carry out wireless communications).

The processor 301 is capable of executing instructions loaded into the random-access memory 302 from the read-only memory 303, from an external memory, from a storage medium (such as an SD card), or from a communication network. When the hardware platform is powered up, the processor 301 is capable of reading instructions from the random-access memory 302 and of executing them. These instructions form a computer program causing the processor 301 to implement all or some of the steps and operations described here.

All or some of the steps and operations described here can thus be implemented in software form by executing a set of instructions by means of a programmable machine, for example a DSP (digital signal processor) or a microcontroller, or be implemented in hardware form by a machine or a dedicated electronic component (chip) or a dedicated set of electronic components (chipset), for example an FPGA (field-programmable gate array) or ASIC (application-specific application circuit) component. In general, the hardware platform comprises electronic circuitry adapted and configured to implement the operations and steps described here.

FIG. 4 schematically illustrates a series of flight segments during which different flight parameters are applied. On departure (“Dep” in FIG. 4), in a first segment S1, first flight parameters Param_1 are applied, typically during a take-off phase. At an instant T1_2, the first flight parameters Param_1 are replaced by second flight parameters Param_2, during a segment S2, typically during an ascent phase. At an instant T2_3, the second flight parameters Param_2 are replaced by third flight parameters Param_3, during a segment S3, typically during a cruise phase. At an instant T3_4, the third flight parameters Param_3 are replaced by fourth flight parameters Param_4, during a segment S4, typically during a descent phase. At an instant T4_5, the fourth flight parameters Param_4 are replaced by fifth flight parameters Param_5, during a segment S5, typically during a landing phase on arrival (“Arr” in FIG. 4). Of course, the series of flight segments which is shown in FIG. 4 is purely illustrative and an aircraft flight can contain a different amount of flight segments during which different flight parameters are applied.

Flight parameters can be changed from one flight segment to another flight segment automatically by the avionics of the aircraft 201. As a variant, flight parameters can be changed from one flight segment to another flight segment by being configured by the pilot (i.e., manually), for example by following the information stored in their electronic flight bag (EFB).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method implemented by electronic circuitry of a system for managing flight parameters of aircraft, the system for managing flight parameters of aircraft being parametrized with overarching flight cost objectives, the method comprising the following steps:
defining, depending on the overarching flight cost objectives, for a first flight, parameters of a cost function F for said first flight relative to N different cost factors Fi;
optimizing flight parameters so as to minimize the cost function F;
programming avionics of an aircraft carrying out said first flight with said flight parameters;
on detecting an event in flight requiring the flight parameters to be revised, recalculating the parameters of the cost function F for the flight relative to the N different cost factors Fi, recalculating the flight parameters, and reprogramming the avionics accordingly;
determining an effective contribution of the first flight to the overarching objectives; and
repeating the method for at least a second flight, taking into account the determined effective contribution.

2. The method according to claim 1, wherein the parameters of the cost function F are coefficients Ci, with i=1, . . . , N, associated, respectively, with the different cost factors Fi according to the formula: F=Σᵢ₌₁^{N}(Cᵢ*Fᵢ).

3. The method according to claim 1, further comprising the following step, for determining the effective contribution of the first flight to the overarching objectives:
retrieving the flight parameters which were actually applied by the avionics during said first flight.

4. The method according to claim 1, wherein the cost factors Fi include at least:
financial costs,
environmental costs,
costs of meteorological uncertainties, and
costs of the risk of flight planning delays.

5. The method according to claim 1, wherein the flight parameters include at least:
vertical trajectory,
lateral trajectory,
speed, and
thrust.

6. The method according to claim 1, wherein the system for managing flight parameters of aircraft is implemented exclusively in a computer platform of a control center of an airline.

7. The method according to claim 1, wherein the system for managing flight parameters of aircraft is implemented jointly by a computer platform of a control center of an airline and the avionics of the aircraft.

8. The method according to claim 6, wherein electronic flight bags serve as intermediaries between the computer platform of the control center of the airline and the avionics of the aircraft.

9. The method according to claim 6 wherein the electronic flight bags serve as intermediaries in addition to wireless communications.

10. The method according to claim 1, wherein, as each flight is composed of a series of flight segments, different flight parameters are applied to each flight segment automatically by the avionics, or by being configured by a pilot.

11. A computer loaded with a computer program comprising code instructions causing the method according to claim 1 to be implemented when said instructions are carried out by a processor.

12. A system for managing flight parameters of aircraft, the system for managing flight parameters of aircraft being parametrized with overarching flight cost objectives and comprising electronic circuitry configured to implement the following steps:
defining, depending on the overarching flight cost objectives, for a first flight, parameters of a cost function F for said first flight relative to N different cost factors Fi;
optimizing flight parameters so as to minimize the cost function F;
programming avionics of an aircraft carrying out said first flight with said flight parameters;
on detecting an event in flight requiring the flight parameters to be revised, recalculating the parameters of the cost function F for the flight relative to the N different cost factors Fi, recalculating the flight parameters, and reprogramming the avionics accordingly;
determining an effective contribution of the first flight to the overarching objectives; and
repeating the method for at least a second flight, taking into account the determined effective contribution.
